(19) United States
(12) Patent Application Publication
(10) Pub. No.: US 2017/0268289 A1
(43) Pub. Date: Sep. 21, 2017

(54) ADJUSTABLE CUTDOWN ROMAN SHADE

(71) Applicant: Springs Window Fashions, LLC, Middleton, WI (US)

(72) Inventors: Cletis Frazier Swopes, Middleton, WI (US); Rebecca Jean Shotwell, Middleton, WI (US)

(21) Appl. No.: 15/460,623

(22) Filed: Mar. 16, 2017

Related U.S. Application Data
(60) Provisional application No. 62/309,112, filed on Mar. 16, 2016.

(51) Int. Cl. E06B 9/262; E06B 9/386; E06B 9/323

(52) U.S. Cl. CPC E06B 9/262; E06B 9/323; E06B 9/386; E06B 2009/2622

(57) ABSTRACT

A window covering comprises a head rail, first and second panels, and first and second bottom rails secured to the first and second panels. A position of the first bottom rail relative to the second bottom rail is adjustable. A third panel can be provided, and a third bottom rail can be secured to a lower portion of the third panel. A position of the third bottom rail relative to the second bottom rail is adjustable. A first rod can be coupled to both the first panel and the third panel to span a gap therebetween. A second rod can be coupled to the second panel. A double rod clip can connect the first rod to the second rod. Single rod clips can secure the first and third panels to the first rod. Each of the rod clips preferably includes a cord guide for guiding and retaining a corresponding lift cord.

### REFERENCE TO RELATED APLPICATIONS

This patent application claims priority to U.S. Provisional Patent Application No. 62/309,112, the entire contents of which is hereby incorporated by reference.

### BACKGROUND

The present invention relates generally to window coverings and window coverings that are adjustable in size.

Options available to consumers for obtaining Roman shades are somewhat limited. Custom sized Roman shades can be ordered to fit a specific window dimension. Custom ordering can result in delay, and the costs for ordering custom size Roman shades can be high. Many retail outlets offer stock size Roman shades for immediate purchase, but the selection available is limited. Accordingly, it is often difficult for a consumer to achieve a satisfactory fit with the stock sizes available. In many cases, stock Roman shades will be oversized to mount outside the window frame. While many types of window coverings are available through programs featuring stock sizes custom cut to a consumer's specifications at the point-of-sale, due to the nature of and materials used for Roman shades, cutdown programs have not featured Roman shades. Accordingly, consumers have had only two options, custom ordering with delay and additional expense or stock sizes that may not fit as desired.

There is a need for a customizable Roman shade that can be sized like a custom blind yet available the same day like a stock or cutdown blind.

### SUMMARY

The present invention provides a window covering comprising a head rail adapted to be mounted adjacent a window, first and second panels in lateral overlapping relation to each other, each panel having an upper portion secured to the head rail, a first bottom rail secured to a lower portion of the first panel, and a second bottom rail secured to a lower portion of the second panel. The first and second bottom rails engage each other (e.g., slidably) to form a bottom rail assembly having an axial length, and a position of the first bottom rail relative to the second bottom rail is adjustable to adjust the length of the bottom rail assembly. Preferably, the first bottom rail includes a downwardly opening track, the second bottom rail includes an upwardly opening track, and the downwardly opening track slidably engages the upwardly opening track.

In one embodiment, the window covering further comprises a third panel positioned in overlapping relation to the second panel (the third panel having an upper portion secured to the head rail), and a third bottom rail secured to a lower portion of the third panel. The third bottom rail engages the second bottom rail and is part of the bottom rail assembly. A position of the third bottom rail relative to the second bottom rail is adjustable (e.g., slidably) to adjust the length of the bottom rail assembly. Preferably, the first and third panels are spaced from each other by a gap, and the window covering further comprises a first rod (e.g., a rear rod) coupled to both the first panel and the third panel and spanning the gap between the first and third panels. The window covering can further comprise a second rod (e.g., a front rod) coupled to the second panel.

A double rod clip can be used to connect the first rod to the second rod. Preferably, the double rod clip engages the first rod in the gap between the first and third panels. Single rod clips can be used to secure the first and third panels to the first rod. Each of the rod clips preferably includes a cord guide for guiding and retaining a corresponding lift cord.

The invention also provides a method of assembling a window covering like the one described above. The method includes shortening (e.g., cutting) the length of the headrail to a first desired length, adjusting an amount of overlap between the first and second panels (e.g., by sliding at least one of the panels relative to the headrail), and moving (e.g., sliding in a telescopic manner) the first bottom rail relative to the second bottom rail to change a length of the bottom rail assembly to a second desired length (e.g., equal to the first desired length). If a third panel and third bottom rail are present, then the method can further include adjusting an amount of overlap between the second and third panels, and moving the third bottom rail relative to the second bottom rail.

Other aspects of the invention will become apparent by consideration of the detailed description and accompanying drawings.

### BRIEF DESCRIPTION OF THE DRAWINGS

FIG. 1 is a rear perspective view of a Roman shade embodying the present invention in the lowered position.

FIG. 2 is the rear perspective view of FIG. 1 with the shade in the raised position.

FIG. 3 is an exploded rear perspective view of the Roman shade of FIG. 1.

FIG. 4 is a rear perspective view of a portion of a headrail of the Roman shade of FIG. 1.

FIG. 5 is a perspective view of a middle portion of the Roman shade of FIG. 1.

FIG. 6 is an exploded perspective view of the Roman shade shown in FIG. 5.

FIG. 7 is a front perspective view of a bottom rail assembly of the Roman shade of FIG. 1.

FIG. 8 is a perspective view of a bottom rail of the Roman shade of FIG. 1.

FIG. 9 is a view of a cord attached to a side panel of the Roman shade of FIG. 1.

FIG. 10 is a bottom view of the cord attached to the side panel of FIG. 8.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Referring now more particularly to the drawings, the illustrated Roman shade 100 includes a headrail assembly 102, a fabric panels section 104, a bottom rail assembly 106, and lift cords 108. Each of the headrail assembly 102, the fabric panels section 104 and the bottom rail assembly 106 is horizontally customizable to provide custom widths within a limited range.

The headrail assembly 102 includes a generally rectangular headrail 110 defining a continuous channel 112 for receiving and holding a plurality of cord motors 114, one such cord motor 114 for each lift cord 108 of the shade 100. Suitable cord motors and the manner for using them are well known to those skilled in the art and will not be described in further detail herein. Alternatively, the motors can be eliminated, and the cords 108 can be manually actuated. The cord motors are axially slidable along the channel 112 defined in the headrail 110. The headrail 110 further defines a continuous retention slot 116 at the front thereof for receiving and securing the fabric panels section 104 in an axially adjustable manner. As used herein, “axially” refers to a direction parallel to the longitudinal extent of the headrail 110. Decorative end caps 118 are provided for the ends of the headrail 110. The headrail 110 is connectable to a plurality of mounting brackets 122 that are attachable to a window structure. Mounting of the headrail 110 using such brackets 122 to secure the location and positioning of a shade is well known to those skilled in the art.

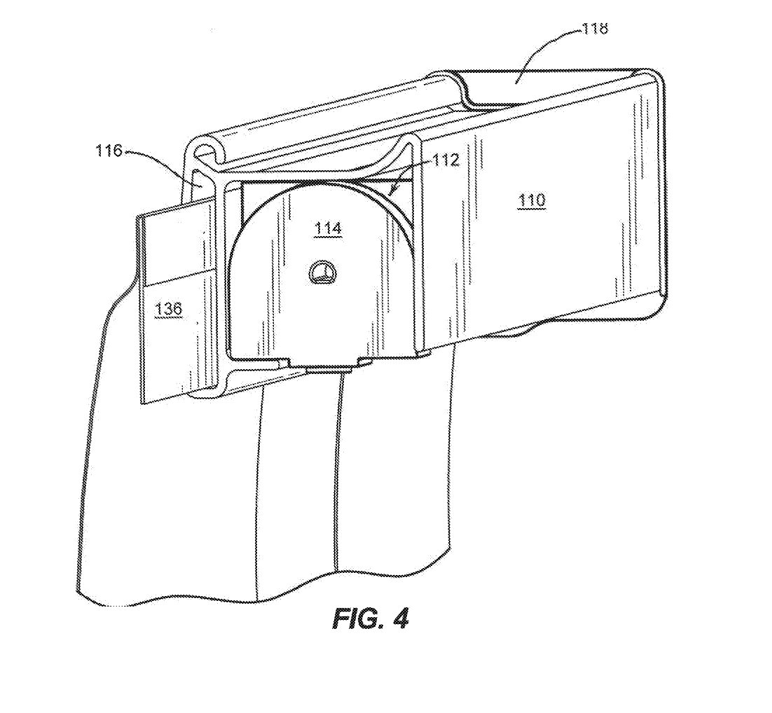

The fabric panels section 104 includes first, second, and third panels 130,132,134 having the tops thereof secured to the headrail 110. Specifically, each of the panels 130,132,134 includes a stiff upper spine 136 (e.g., made of wood, cardboard, or plastic) bonded or otherwise secured to an upper edge of the corresponding panel, and each upper spline 136 is slid axially into the retention slot 116 of the headrail, as generally shown in FIG. 4. The panels 130, 132, 134 are overlapping, with the second panel 132 overlapping the inner ends of the first and third panels 130, 134. Accordingly, by sliding the upper splines 136 in the retention slot 116, the axial position of each of the first and third panels 130, 134 is adjustable behind the second panel 132 to vary the overall width of the fabric panels section 104. Each of the panels 130,132,134 further includes a stiff lower spine 138 (e.g., made of wood, cardboard, or plastic) bonded or otherwise secured to a lower edge of the corresponding panel, and each lower spline 138 is secured to the bottom rail assembly 106, as described below in more detail

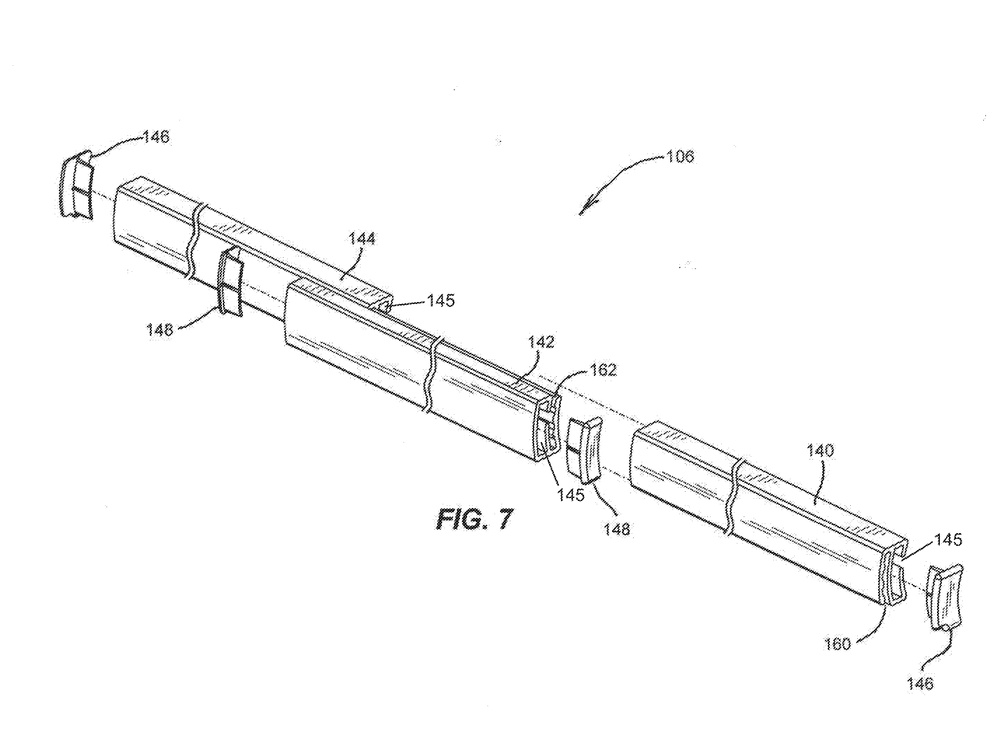

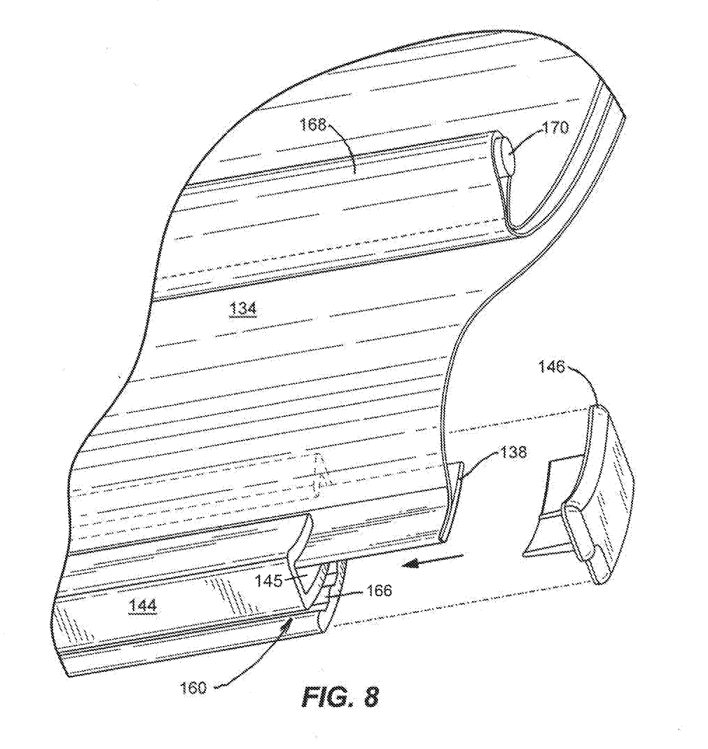

Referring to FIG. 7, the bottom rail assembly 106 includes first, second, and third bottom rails 140,142,144 that telescopically overlap with each other, with the inner ends of the first and third bottom rails 140,144 received in and sliding behind the second bottom rail 142. Each of the bottom rails 140,142,144 includes a continuous retention slot 145 for receiving and securing a corresponding fabric panel 130,132,134 and in an axially adjustable manner. Specifically, the lower spline 138 of each fabric panel 130,132,134 can be slid axially into the corresponding bottom rail 140,142,144, respectively, as shown in FIG. 8.

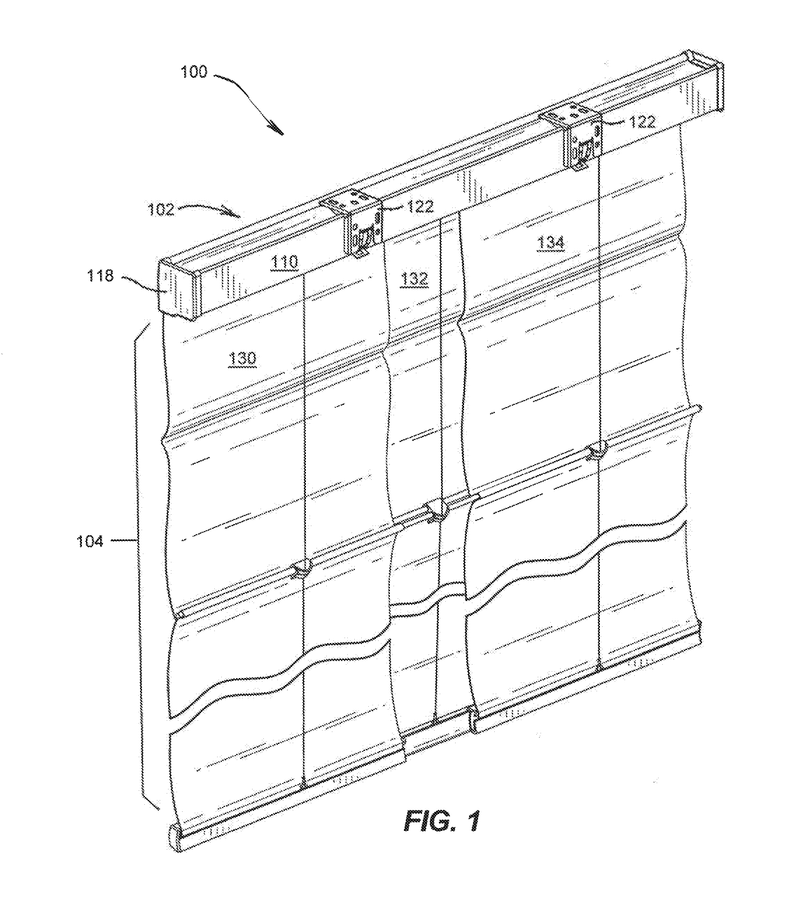

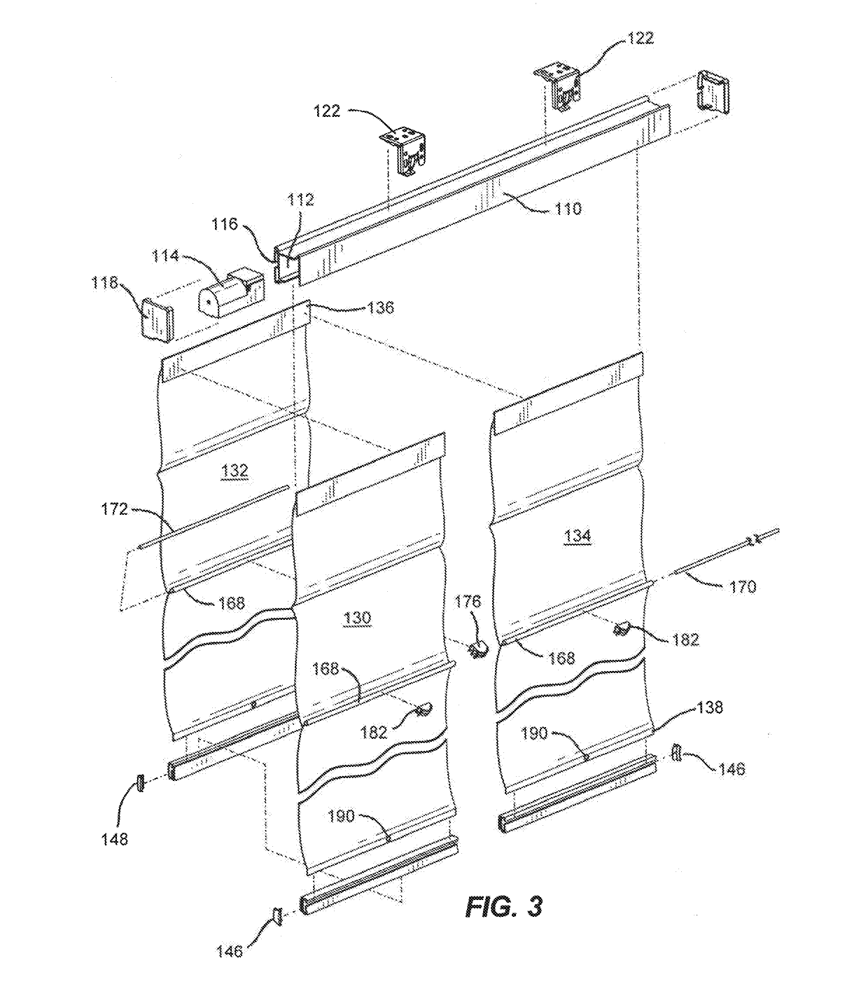

As best shown in FIGS. 1 and 3, widths of the illustrated bottom rails 140,142,144 correspond to the widths of the corresponding first, second, and third panels 130,132,134. Referring to FIGS. 3, 7, and 8, a large endcap 146 is provided on the outer end of each of the first and third bottom rails 140,144, and two small end caps 148 are provided on the ends of the second bottom rail 142 to close the exposed ends of the bottom rails 140,142,144.

The bottom rails 140,142,144 engage each other in sliding relationships to form a continuous bottom rail assembly 106 at the bottom edge of the fabric panels section 104. To establish the sliding engagement between the bottom rails 140, 142, 144, the first and third bottom rails 140,144 define a downwardly oriented tracks 160, and the second bottom rail 142 defines an upwardly oriented track 162. Axially extending ridges 166 are provided on the inside of each of the tracks 160,162 to facilitate snug engagement between the tracks of the bottom rails 140,142,144 to retain the relative positioning after adjustment.

Each of fabric panels 130,132,134 defines horizontally extending pleats 168. To secure and control the registration of the pleats 168 from one fabric panel to the next fabric panel, each of the illustrated panels 130,132,134 includes pairs of rods 170,172 inserted into sewn loops of fabric in the panels 130,132,134. One rod of each rod pair is a long rod 170 that extends from the pleat 168 of the first fabric panel 130 into the pleat of the third fabric panel 134, resulting in apportion of the long rod 170 being exposed in a gap 174 between the first and third panels 130,134. The other rod of each rod pair is a short rod 172 that extends through the pleat of the second fabric panel 134.

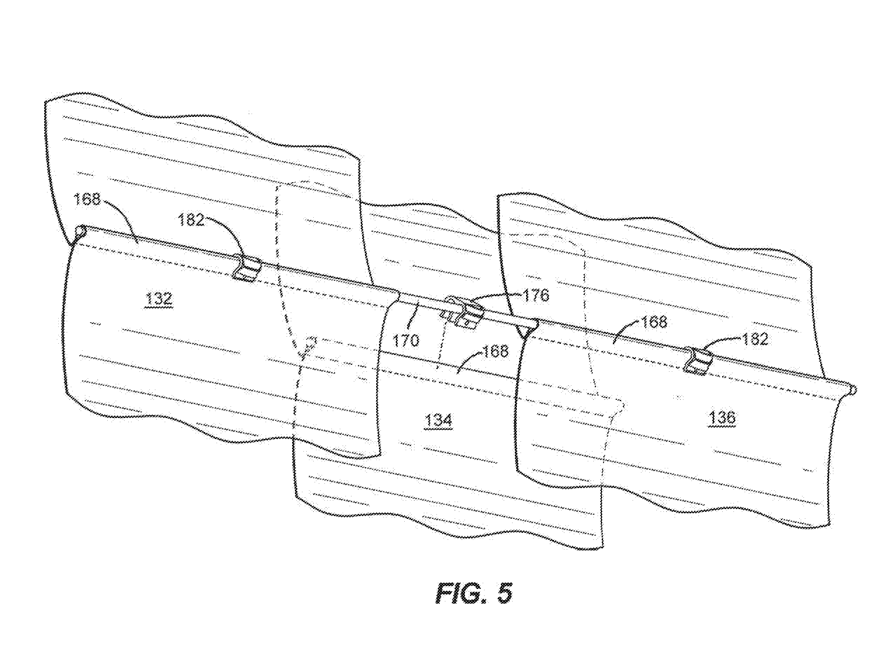

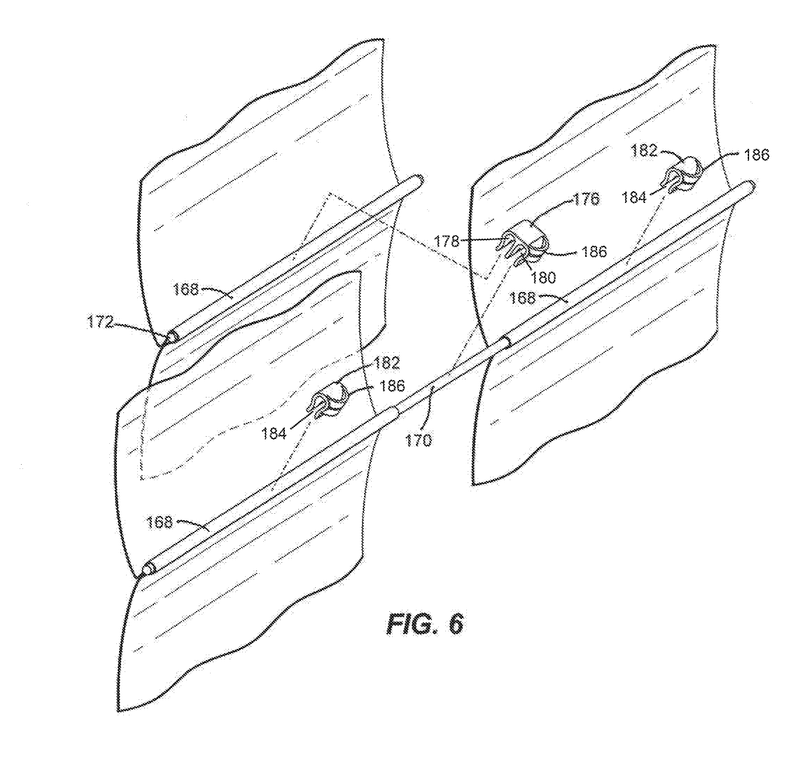

In order to secured the horizontal alignment of the rods 170,172, each rod pair includes a double rod clip 176, as shown in FIGS. 5 and 6. Each double rod clip 176 includes a front passage 178 for receiving the short rod 172 and corresponding pleat material from the second panel 132, and a rear passage 180 for receiving the long rod 170. If desired, a fastener such as a screw can be threaded through the double rod clip 176 to further secure the position of the double rod clip 176 relative to the rods 170,172. Although the rear passage 180 is shown as an open passage that allows the double rod clip 176 to be slid over the side of the long rod 170, the rear passage 180 could instead be a closed passage that requires the long rod 170 to be slid axially through the rear passage 180.

Each rod pair further includes two single rod clips 182 that each have a single passage 184 for receiving the long rod 170 and corresponding pleat material from the first and third panels 130,134, as shown in FIGS. 5 and 6. If desired, fasteners such as screws can be threaded through the single rod clips 182 to further secure the position of the single rod clips 176 relative to the long rod 170.

Each of the double and single rod clips 176,182 includes a cord guide 186 for guiding and retaining the position of the corresponding lift cord 108 relative to the pleats. Specifically, each lift cord 108 extends downwardly from the headrail 110 (e.g., from a manual or powered spool or pulley system, as is known in the art) and passes through the corresponding series of aligned cord guides 186 and is secured to the bottom rail assembly 106. In the illustrated embodiment, there is one lift cord for each of the three panels, but it should be understood that other numbers of lift cords and panels can be used.

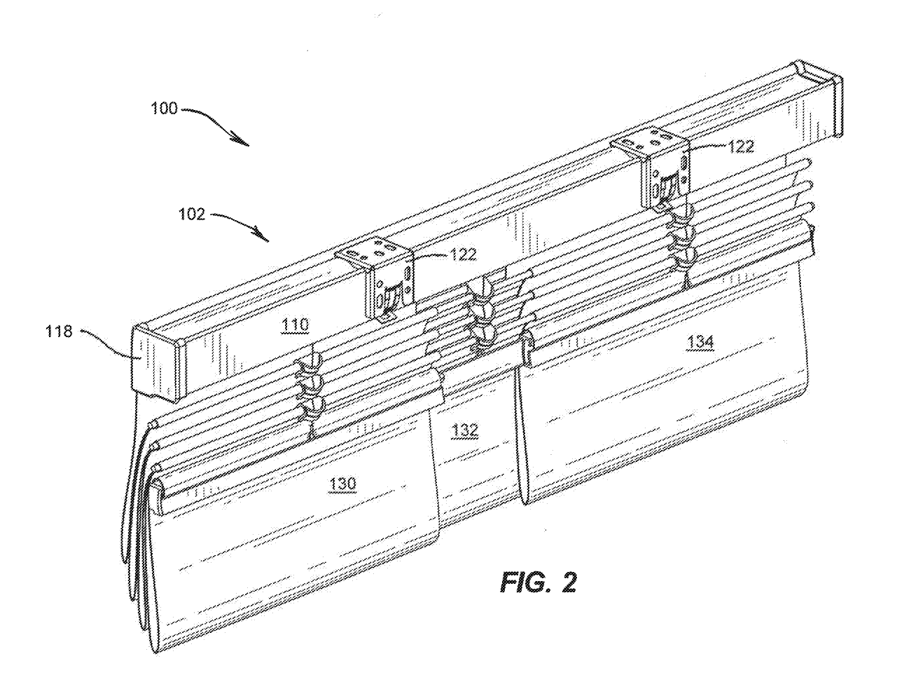

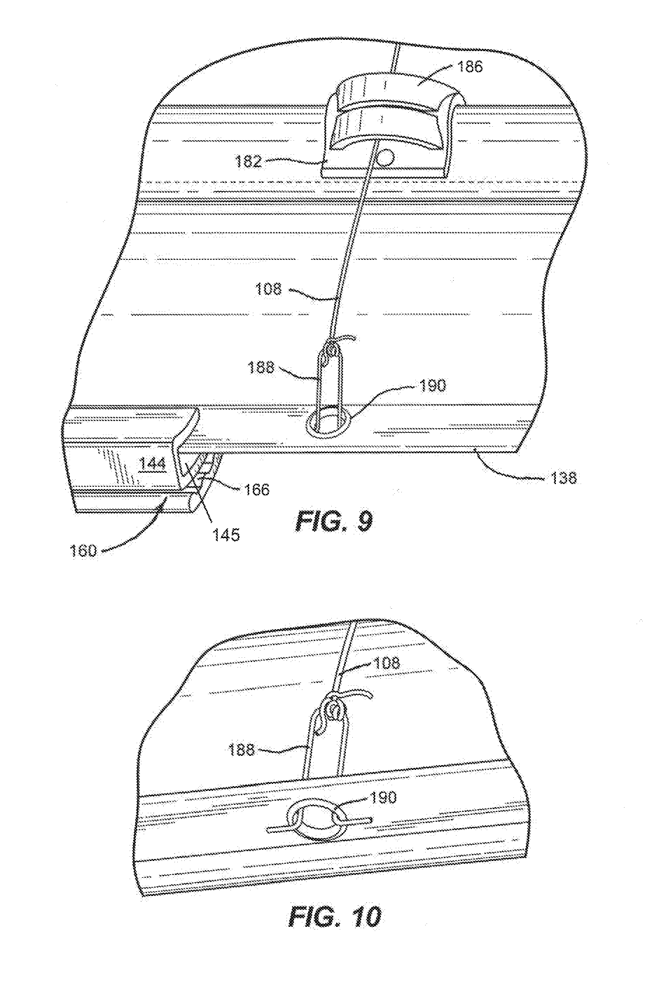

Referring to FIGS. 9-10, each lift cord 108 is secured to the bottom rail assembly 106 by a cord fastener 188 secured to the lower end of the corresponding panel. Specifically, an eyelet 190 is inserted through the lower end of the fabric panel and corresponding lower spline 138, and the cord fastener 188 is inserted through and retained in the eyelet. The cord fastener 188 and eyelet 190 are sufficiently thin that they can be slid into the retention slot 145 of the corresponding bottom rail segment 140,142,144. In the fully assembled condition, only the uppermost end of the cord fastener 188 is visible above the bottom rail segment, as shown in FIGS. 1 and 2.

Roman shades as described above can be provided in a few specified sizes to provide custom sized shades within a range. To achieve a desired shade size, an appropriate stock size is selected. The headrail 110 is cut to the required length in an appropriate cutdown machine. It is anticipated that headrails similar to those used in the window coverings of other cutdown programs can be used for the Roman shade described herein so that the headrail can be cut in existing cutdown machines used for other cutdown programs.

In order to cut down the axial length of the Roman shade 100, the first and third fabric panels 130, 134 are slid toward the second fabric panel 132 so that the upper edges of the fabric panels contained in the retention slot 116 are moved away from the end portions of the headrail 110. The cord motors 114 are also moved toward the center of the headrail 110, thereby leaving end portions of the headrail 110 empty and suitable for cutting. Preferably, equal portions are cut from each end of the headrail 110 to achieve the desired final width. However, cutting from just one or the other end of the headrail 110 also can be performed. After the headrail is cut to the desired width, the first and third fabric panels 130, 134 are slid laterally outward to the maximum remaining width of the headrail 110. Generally, it is desirable to center the second panel 132 in the final assembly. While moving the fabric panels, the cord motors 114 can be moved as required to remain in vertical alignment with the lift cords and cord guides 186 attached to the fabric panels 130,132,134. The telescopic arrangement of the bottom rails 140, 142, 144 is adjusted so as to align each of the bottom rails with the corresponding fabric panel.

In this way, a custom sized Roman shade can be provided with sizing performed at the point-of-sale to provide a consumer with the desired shade immediately at a specified size.

Various features and advantages of the invention are set forth in the following claims.

1. A window covering comprising:
a head rail adapted to be mounted adjacent a window;
first and second panels in lateral overlapping relation to each other, each panel having an upper portion secured to the head rail;
a first bottom rail secured to a lower portion of the first panel; and
a second bottom rail secured to a lower portion of the second panel, wherein the first and second bottom rails engage each other to form a bottom rail assembly having an axial length, and wherein a position of the first bottom rail relative to the second bottom rail is adjustable to adjust the length of the bottom rail assembly.

2. A window covering as claimed in claim 1, wherein the first and second bottom rails slidably engage each other to facilitate adjustment to the length of the bottom rail assembly.

3. A window covering as claimed in claim 2, wherein the first bottom rail includes a downwardly opening track and the second bottom rail includes an upwardly opening track, and wherein the downwardly opening track slidably engages the upwardly opening track.

4. A window covering as claimed in claim 1, further comprising:
a third panel positioned in overlapping relation to the second panel, the third panel having an upper portion secured to the head rail; and
a third bottom rail secured to a lower portion of the third panel, the third bottom rail engaging the second bottom rail and being part of the bottom rail assembly, wherein a position of the third bottom rail relative to the second bottom rail is adjustable to adjust the length of the bottom rail assembly.

5. A window covering as claimed in claim 4, wherein the first, second, and third bottom rails slidably engage each other to facilitate adjustment to the length of the bottom rail assembly.

6. A window covering as claimed in claim 5, wherein the first bottom rail includes a downwardly opening track, the second bottom rail includes an upwardly opening track, and the third bottom rail includes a downwardly opening track, wherein the upwardly opening track of the second bottom rail slidably engages the downwardly opening tracks of the first and third bottom rails.

7. A window covering as claimed in claim 4, wherein the first and third panels are spaced from each other by a gap, and wherein the window covering further comprises a first rod coupled to both the first panel and the third panel and spanning the gap between the first and third panels.

8. A window covering as claimed in claim 7, further comprising a second rod coupled to the second panel.

9. A window covering as claimed in claim 8, further comprising a double rod clip connecting the first rod to the second rod.

10. A window covering as claimed in claim 9, wherein the double rod clip includes a cord guide, and wherein the window covering further includes a lift cord connecting the headrail to the bottom rail assembly, the lift cord passing through the cord guide.

11. A window covering as claimed in claim 10, wherein the double rod clip engages the first rod in the gap between the first and third panels.

12. A window covering as claimed in claim 11, wherein the lift cord is a central lift cord, and wherein the window covering further includes a first single rod clip securing the first panel to the first rod and a second single rod clip securing the third panel to the first rod, wherein each single rod clip includes a cord guide, and wherein the window covering further includes first and second side lift cords connecting the headrail to the bottom rail assembly, the first side lift cord passing through the cord guide of the first single rod clip and the second side lift cord passing through the cord guide of the second single rod clip.

13. A window covering as claimed in claim 1, wherein the first panel includes a first fastener secured to the lower end of the first panel and the second panel includes a second fastener secured to the lower end of the second panel, and wherein the window covering further includes:
a first cord connecting the headrail to the first fastener; and
a second cord connecting the headrail to the second fastener.

14. A window covering as claimed in claim 13, wherein the first and second fasteners each comprise a spring clip removably inserted into an opening in the lower end of the first and second panels, respectively

15. A method of assembling a window covering including a headrail having a length, first and second panels, and a bottom rail assembly having first and second bottom rails engaged with each other, the method comprising:
shortening the length of the headrail to a first desired length;
adjusting an amount of overlap between the first and second panels; and
moving the first bottom rail relative to the second bottom rail to change a length of the bottom rail assembly to a second desired length.

16. A method as claimed in claim 15, wherein shortening includes cutting the headrail.

17. A method as claimed in claim 15, wherein adjusting including sliding at least one of the first and second panels relative to the headrail.

18. A method as claimed in claim 15, wherein moving comprises sliding the first bottom rail relative to the second bottom rail.

19. A method as claimed in claim 15, wherein the window covering further includes a third panel and wherein the method further comprises adjusting an amount of overlap between the second and third panels.

20. A method as claimed in claim 15, wherein the second desired length is substantially the same as the first desired length.
